(19) United States
(12) Patent Application Publication
(10) Pub. No.: US 2015/0095224 A1
(43) Pub. Date: Apr. 2, 2015

(54) Customised Interaction With Computer Equipment

(71) Applicant: MASTERCARD INTERNATIONAL INCORPORATED, Purchase, NY (US)

(72) Inventor: Simon Blythe, Cambridgeshire (GB)

(21) Appl. No.: 14/497,509

(22) Filed: Sep. 26, 2014

(30) Foreign Application Priority Data
Sep. 27, 2013 (GB) 1317157.4

(51) Int. Cl. G06Q 20/32; G06Q 20/10; G06Q 20/34

(52) U.S. Cl. CPC G06Q 20/3223; G06Q 20/341; G06Q 20/1085
USPC 705/41

(57) ABSTRACT

A method of customised interaction with computer equipment is described. The computer equipment comprises a processor, a display, a memory and a user input means. A local connection is established between mobile computing apparatus and the computer equipment. Customised interaction code is then provided from the mobile computing apparatus for storage in the memory of the computer equipment. The processor of the computer equipment then runs the customised interaction code to provide a customised user interface using the display and the user input means during the local connection between the mobile computing apparatus and the computer equipment. Suitable mobile computing apparatus is also described.

### FIELD

This disclosure relates to customised interaction with computer equipment. It is particularly relevant to customisation of interaction between a mobile computing device and a terminal. Embodiments of the disclosure relate particularly to the use of transaction cards or transaction card proxies with automated teller machines (ATMs) or other terminals in a financial transaction system, such as EMV.

### BACKGROUND

EMV is a financial transaction system based around the use of contact and contactless transaction cards. In the EMV payment model, an issuing bank provides an account holding customer with a smart card (or other token) to use when making payments. An acquiring bank provides a merchant with a compatible terminal device to use when accepting payments. The term “terminal” here is considered to cover any device that interfaces directly with such a transaction card (e.g. an interface allowing user entry of a personal identification number (PIN) such as a PIN pad or PIN Entry Device (PED), or a POS terminal or Automated Teller Machine (ATM) comprising means such as these, to allow interaction with a transaction card). A customer will typically obtain cash and perform account management operations using an ATM—ATMs often have extended functionality allowing transactions to be made (such as top up payments to mobile phone pay as you go accounts).

The cardholder will generally have a direct relationship with the issuing bank, which will take responsibility for supply and management of the transaction card and for any application software loaded onto it. In the merchant space, there is much more diversity in terminal supply and management.

Merchant terminals may be supplied and managed directly by an original equipment manufacturer (OEM), who will then also take responsibility for fixing bugs in terminal software and for updating terminal capabilities. Some merchants will take responsibility for terminal management and for any patching required themselves. In other cases, terminal supply and management is handled by intermediaries, which provide varying levels of maintenance and support. ATMs are typically controlled by banks, or groups of banks, but in some cases are controlled by other merchants. Many different types of ATMs are in service—different banks will typically use different ATM machine types, and some banks may have many different models in service.

This diversity in ATM ownership and ATM type means that the customer experience is highly inconsistent between ATM machines. While this does not prevent the customer from using ATMs, it may lead to slower use (as the customer works out how to use an unfamiliar interface) and increased likelihood of error. The customer may also have preferences for ATM use, for example, a list of additional services that the customer would like to be offered if available, and a list of additional services that the customer would not wish to be offered. At present, there is no way to respect the preferences of an individual customer. It would be desirable to address these issues, both for ATMs and also for other terminal types.

### SUMMARY

In a first aspect, the present disclosure provides a method of customised interaction with computer equipment comprising a processor, a display, a memory and a user input means, the method comprising: establishing a local connection between mobile computing apparatus and the computer equipment; providing customised interaction code from the mobile computing apparatus for storage in the memory of the computer equipment; and the processor of the computer equipment running the customised interaction code to provide a customised user interface using the display and the user input means during the local connection between the mobile computing apparatus and the computer equipment.

This approach allows for ready customisation of a user interface in accordance with user preferences. Moreover, it allows this to be achieved by local interaction, without any need for the computer equipment to obtain user details from a remote network.

In one exemplary embodiment, the customised interaction code is deleted from the memory of the computer equipment after use of the customised user interface. This ensures that the customised interaction code does not affect other user activity, or leave traces which may compromise the original user. To achieve this, the customised interaction code may be deleted from the memory of the computer equipment before the local connection between the mobile computing apparatus and the computer equipment ends.

Various options are possible to provide greater security. In one exemplary embodiment, the memory for storing the customised interaction code is a dedicated cache. The computer equipment may also establish that the customised interaction code is provided or assured by a trusted source.

For effective customisation, the customised user interface may provide user interface options previously determined by or for the user. The customised interaction code stored in the mobile computing apparatus may in embodiments be modified during the local connection.

This approach may be applied very effectively in the context of financial transaction technology. For example, the mobile computing apparatus may be a payment card, or a mobile telephone acting as a proxy for a payment card. The computer equipment may be a terminal of a financial transaction system. This terminal may be an automated teller machine (ATM).

In a second aspect, the disclosure provides a method of using mobile computing apparatus to obtain a customised interaction with computer equipment comprising a processor, a display, a memory and a user input means, the method comprising: establishing a local connection with the computer equipment; and providing customised interaction code to the computer equipment over the local connection; wherein the customised interaction code is adapted on being run by the computer equipment to provide a customised user interface using the display and the user input means during the local connection between the mobile computing apparatus and the computer equipment.

In one exemplary embodiment, the customised user interface provides user interface options previously determined by or for the user. The mobile computing apparatus may also provide evidence that the customised interaction code is provided or assured by a trusted source. In some arrangements, the customised interaction code stored in the mobile computing apparatus is modified during the local connection. The mobile computing apparatus may for example be a payment card or a mobile telephone acting as a proxy for a payment card.

In a third aspect, the disclosure provides a payment card comprising a processor, a memory and local connection means, wherein the memory stores customised interaction code and application software, and wherein the processor when programmed with the application software is adapted to perform the method of the second aspect of the disclosure as set out above.

In some arrangements, the local connection means comprises contacts to make a connection with a contact card reader. The local connection means may also comprise means to establish a contactless connection with a card reader.

In a fourth aspect, the disclosure provides a method of providing a customised interaction at the computer equipment comprising a processor, a display, a memory and a user input means, the method comprising: establishing a local connection with a mobile computing apparatus; receiving a customised interaction code from the mobile computing apparatus and storing the customised interaction code in the memory of the computer equipment; and the processor of the computer equipment running the customised interaction code to provide a customised user interface using the display and the user input means during the local connection between the mobile computing apparatus and the computer equipment.

In one exemplary embodiment, the customised interaction code is deleted from the memory of the computer equipment after use of the customised user interface. The customised interaction code may be deleted from the memory of the computer equipment before the local connection with the mobile computing apparatus ends. The memory for storing the customised interaction code may be a dedicated cache.

The method may further comprise establishing that the customised interaction code is provided or assured by a trusted source.

In embodiments, the computer equipment is a terminal of a financial transaction system and comprises a card reader for reading a payment card. The terminal may, for example, be an automated teller machine (ATM).

### DRAWINGS

Embodiments of the disclosure will now be described, by way of example, with reference to the accompanying Figures, of which:

FIG. 1 shows an infrastructure in which embodiments of the disclosure may be used;

FIG. 2 illustrates schematically a payment card and terminal in combination suitable for use in embodiments of the disclosure;

FIG. 3 illustrates schematically a mobile telephone used as a proxy for a payment card and terminal in combination suitable for use in embodiments of the disclosure;

FIGS. 4a and 4b indicate the elements of a payment card and a mobile telephone, respectively, suitable for use in embodiments of the disclosure;

FIG. 5 indicates the elements of a terminal suitable for use in embodiments of the disclosure;

FIG. 6 provides a flow diagram indicating steps of a method according to an aspect of the disclosure;

FIG. 7 is a block diagram indicating process steps carried out at a payment device using an embodiment of the disclosure; and

FIG. 8 is a block diagram indicating process steps carried out at a terminal using an embodiment of the disclosure.

### DETAILED DESCRIPTION

Specific embodiments of the disclosure will be described below with reference to the Figures.

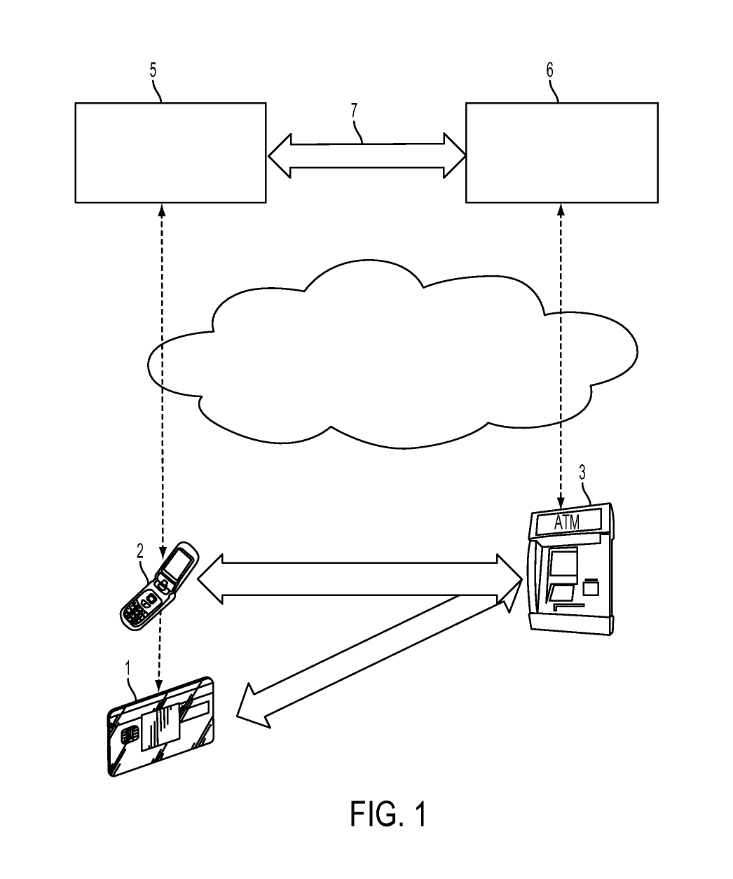

FIG. 1 shows an infrastructure in which embodiments of the disclosure may be used. The environment shown is a banking infrastructure, but embodiments of the disclosure may be employed in other computing infrastructures that have similar properties.

User computer devices are provided in the form of payment devices. These may be, for example, payment cards 1 or payment card proxies such as mobile phones 2. These devices have processors and memories for storing information including firmware and applications run by the respective processors. The devices also have means to enable local communication. These may comprise contacts on a payment card 1 to allow communication by protocols such as those defined under ISO/IEC 7816, they may comprise antennae and associated hardware and software to enable communication by NFC and associated contactless card protocols such as those defined under ISO/IEC 14443, or they may comprise an antenna and associated hardware and software to allow local wireless networking using 802.11 protocols or any combination of the above.

These user computer devices are mobile. Other computer equipment in the infrastructure is typically fixed, such as point of interaction (POI) terminals 3, of which the example shown is an ATM (another example would be a point-of-sale (POS) terminal). Such equipment is typically connected or connectable to an acquiring bank 5 or other service provider in a secure way (either through a dedicated channel or through a secure communication mechanism over a public or insecure channel). There may also be a mechanism to allow connection between the user computer devices and a card issuing bank 6 or service provider associated with the user. A banking infrastructure 7 will also connect the card issuer 6 and the acquiring bank 5, allowing transactions to be carried out between them.

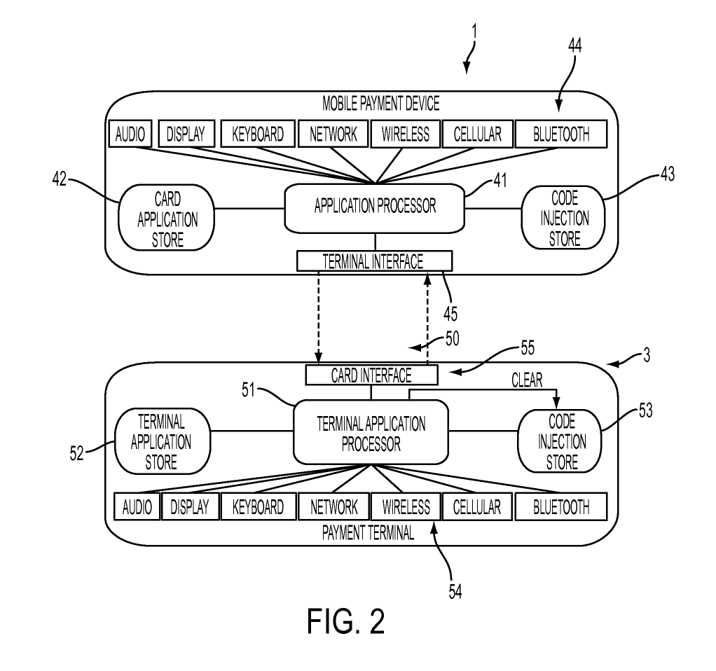

FIG. 2 generally illustrates a smart card, such as an EMV payment card 1, with an additional “code injection” memory area containing terminal application code. A card application is used to inject the code into a dedicated memory area in a payment terminal such as POI terminal 3. A communication channel 50 is provided between the payment card 1 and the terminal 3, such as an ISO7816 contact interface or an ISO14443 contactless interface (as indicated by the dashed lines in FIG. 2). The payment terminal 3 includes a dedicated “code injection” memory area to receive and execute code injected by the payment card 1. A secure clearing mechanism erases injected code after each session to prevent potential exploitation of the mechanism or fraud.

In particular, FIG. 2 shows schematically functional elements of the payment card 1 and the POI terminal 3 suitable for use in embodiments of the disclosure. The payment card 1 is in this case an EMV card with normal EMV functionality but having an additional memory area (either an additional memory or a dedicated area of existing memory) containing customised interaction code. The card application processor 41 of the payment card 1 is shown as having a card application store 42 in which all EMV applications are stored (including the application which runs the code injection process) and a code injection store 43, in which the code to be provided to a POI terminal is stored. The card application processor 41 is with appropriate hardware adapted to perform a range of functions 44. These may include different communication types (WiFi, cellular and Bluetooth, for example, for local networking, together with means to support other networking layers) and may include user interaction functions (audio, display and keyboard). The appropriate hardware will typically not be present in the payment card 1 itself (though in certain cases it may be—payment cards 1 may be provided with Bluetooth functionality, for example), but the card application processor will be able to control appropriate hardware when connected to it using this functionality.

A communication channel 50 is provided between a terminal interface 45 on the payment card 1 and a card interface 55 on the POI terminal 3. This communication channel may be implemented in any appropriate way. For example, it may be a contact connection under ISO7816 between a contact pad on the payment card 1 and a card reader in the POI terminal 3, or it may be a contactless connection under ISO14443 using NFC protocols between NFC interfaces on the transaction card 1 and the POI terminal 3.

The other elements of the POI terminal 3 can be considered as broadly complimentary to similar elements in the payment card 1. The terminal application processor 51 has a terminal application store 52 holding applications run by the terminal, together with a code injection store 53 for storing code provided in a code injection process. As is shown in FIG. 2, the terminal application processor 51 is adapted to clear the code injection store 53, typically at the end of a transaction process. It is preferred that this clearing mechanism operates securely to erase any injected code after a session to prevent any exploitation of this mechanism for fraud. The transaction application processor 51 is also, with appropriate hardware, adapted to perform a range of functions 54. These may include different communication types (WiFi, cellular and Bluetooth, for example, for local networking, together with means to support other networking layers) and may include user interaction functions (audio, display and keyboard). The appropriate hardware will typically be present in the POI terminal 3.

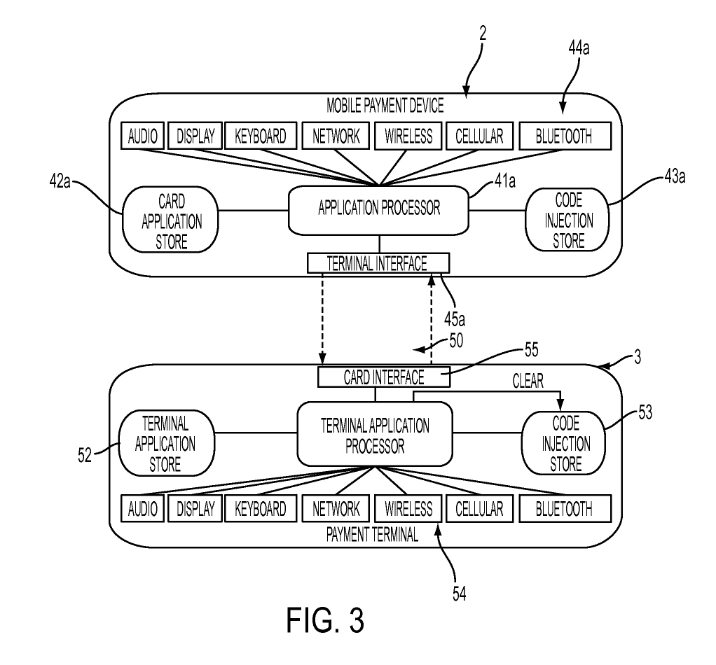

FIG. 3 generally illustrates a mobile payment device, such as a smartphone 2, with an additional “code injection” memory area containing terminal application code. A mobile application is used to inject the code into a dedicated memory area in a payment terminal, such as the POI terminal 3. A communication channel 50 is provided between the mobile device 2 and the terminal 3, such as an ISO14443 contactless interface (as indicated by the dashed lines in FIG. 3). The payment terminal 3 includes a dedicated “code injection” memory area to receive and execute code injected by the mobile device 2. A secure clearing mechanism erases injected code after each session to prevent potential exploitation of the mechanism or fraud.

In particular, FIG. 3 shows schematically functional elements of the mobile phone 2, used as a proxy for a payment card, and the POI terminal 3 suitable for use in embodiments of the disclosure. For the purposes of the disclosure, the mobile phone 2 has essentially the same functional elements as the payment card 1, differing primarily in that code injection is achieved using a mobile application on the mobile phone 2 rather than a card application on the payment card 1. There is a mobile applications processor 41a, a mobile applications store 42a and a code injection store 43a. A plurality of networking and user interface functions 44a are also provided. The mobile phone 2 will, however, itself have access to appropriate networking and user interface hardware, though it may also be able to control other such appropriate hardware when connected to it. The communication channel 45a to the POI terminal 3 is as before (though in practice this is likely to be implemented contactlessly using an NFC protocol), and the schematic elements of the POI terminal 3 are as shown in FIG. 2.

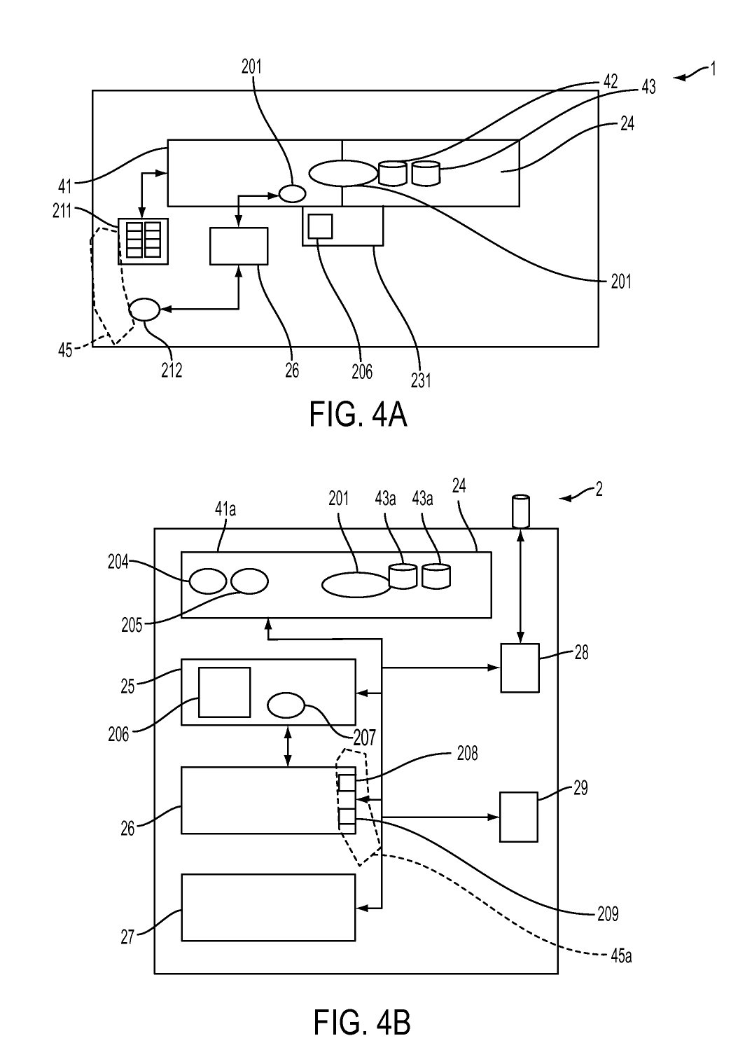

The components of a transaction card 1 and a mobile phone 2 suitable for implementing embodiments of the disclosure are shown in more detail in FIGS. 4a and 4b. FIG. 4a illustrates a payment card 1, whereas FIG. 4b illustrates a mobile telephone 2 as an example of a mobile computing device usable as a proxy for a payment card.

FIG. 4a shows schematically relevant parts of a representative hardware and software architecture for a transaction card such as a payment card 1 (particularly an EMV payment card) suitable for implementing an embodiment of the disclosure. The payment card 1 comprises an application processor 41, one or more memories 24 associated with the application processor and a NFC controller 26. Either within the application processor and memory structure or as a separate element there may be provided a security domain 206 adapted to support cryptographic actions. This is shown here as a part of a separate secure element 231. The payment card 1 is equipped with a contact pad 211 for contact transactions using contact card protocols such as ISO/IEC 7816 and also comprises an antenna 212 connected to NFC controller 26 to allow transactions under contactless card protocols such as those defined under ISO/IEC 14443.

In the arrangement shown, the application processor 41 and associated memories 24 comprise (shown within the processor space, but with code and data stored within the memories) a code injection application 201. The memories 24 contain a card application store 42 (storing the code for the code injection application 201) and also a code injection store 43 with injection code. The application processor 41 provides an NFC application 207 which interfaces with the NFC controller 26. The code injection interface 45 may be established over a contact card interface, a contactless card interface, or any other communication channel available to the card for communicating with a terminal (either general purpose or dedicated to the purpose).

FIG. 4b shows schematically relevant parts of a representative hardware and software architecture for a mobile computing device suitable for implementing an embodiment of the disclosure. In the example shown, the mobile computing device is a mobile cellular telecommunications handset (“mobile phone” or “mobile device”). In other embodiments, the computing device may be another type of computing device such as a laptop computer or a tablet. The computing device need not have cellular telecommunications capabilities, and one of the computing devices need not even be mobile (in principle, embodiments of the disclosure could be provided in which neither computing devices were mobile, though in most practical applications envisaged at least one computing device would be mobile).

Mobile phone 2 comprises an application processor 41a, one or more memories 24 associated with the application processor, a SIM or USIM 25 itself comprising both processing and memory capabilities and a NFC controller 26. The mobile phone 2 also has a display controller 27 for a display, providing for example a touchscreen user interface. The mobile phone 2 is equipped with wireless telecommunications apparatus 28 for communication with a wireless telecommunications network and local wireless communication apparatus 29 for interaction by NFC.

In the arrangement shown, the application processor 41a and associated memories 24 comprise (shown within the processor space, but with code and data stored within the memories) a code injection application 201. These will also contain other applications normally needed by such a device, such as a browser 204 and a modem 205, shown here for convenience in the processor space. The memories 24 contain a mobile application store 42a (storing the code for the code injection application 201) and also a code injection store 43a with injection code. The SIM/USIM 25 will comprise a security domain 206 adapted to support cryptographic actions and an NFC application 207 which interfaces with the NFC controller 26, which has interfaces 208 to NFC devices and tags. This may also provide card emulation 209 to allow the mobile phone 2 to emulate a contactless card. The code injection interface 45a may be established over any of these communication channels (or in principle over any other channel, either general purpose or dedicated to the purpose).

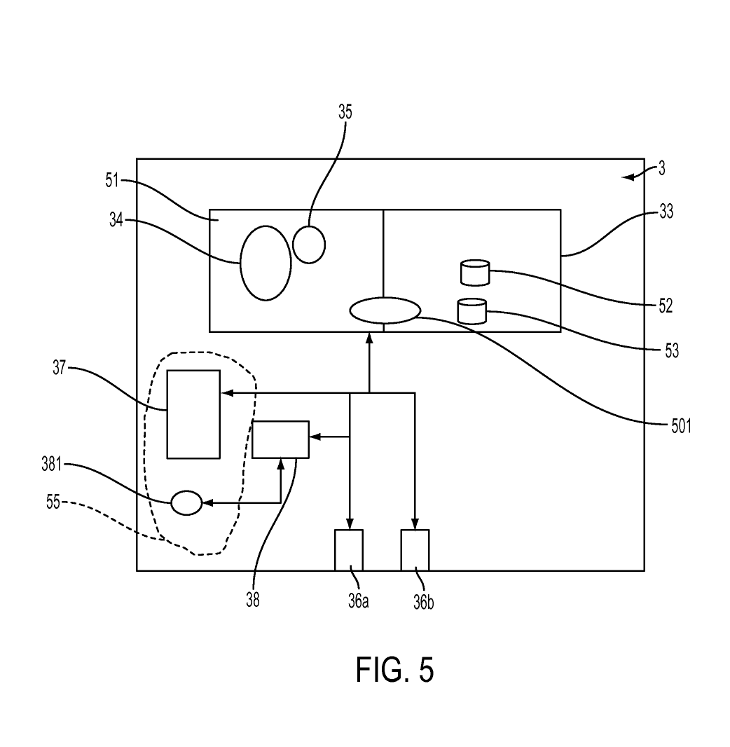

FIG. 5 illustrates the functional features of a terminal for use in embodiments of the disclosure in more detail. The terminal 3 has a processor 51 and associated memories 33. The base function of the terminal 3 in the case shown is to operate as a point of interaction (POI) with a financial system. Such a terminal may, for example, be a point of sale (POS) terminal but may in preferred cases be an automated teller machine (ATM). In other embodiments, the terminal 3 may have another function altogether (for example, a ticketing machine for a transportation network). In the case shown, the terminal 3 has an operating system 34 and transaction software 35 (these may be provided together in a single assemblage of code, or may both be divided into a number of different components, but are represented here as two elements for convenience). The operating system 34 manages hardware resources and provides common services for applications, whereas the transaction software 35 performs the base function of the terminal 3 and may be provided (for example) as one or more applications. For the user interface of the terminal 3, the basic operation of the user interface functions such as display 36a and user input means (for example touchscreen or keypad) 36b may be determined by the operating system, with the specific use of the user interface options determined by the transaction software 35. As is discussed below, these user interface options (and optionally other elements of the transaction software 35) may be overridden by injected code. The terminal 3 will have means to make a connection to a device such as a transaction card. In this case, the terminal 3 has a contact card reader 37 and an NFC controller 38 and antenna 381 to allow a contactless card connection to a contactless card, or a device such as an NFC-enabled mobile telephone able to act as a proxy for a contactless card.

The application processor 51 and associated memories 33 also comprise (shown within the processor space, but with code and data stored within the memories) a code injection application 501. The memories 33 contain a terminal application store 52 (storing the code for the code injection application 501) and also a code injection store 53 with injection code. As indicated above, the code injection store 53 is preferably provided as a discrete memory, either physically discrete, or established as a discrete element by virtualisation or by dedication of a particular memory location to this purpose. The code injection interface 55 may be established through the contact card reader 37 or through the NFC controller 38, or indeed any other appropriate local connection.

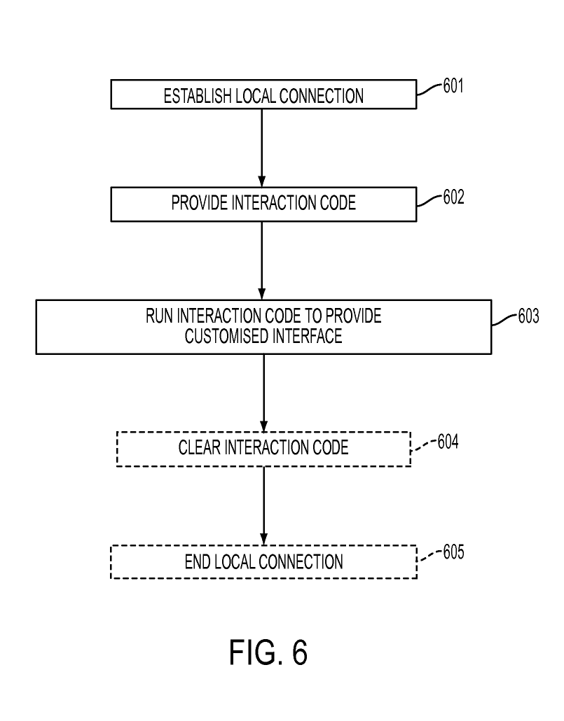

FIG. 6 illustrates steps of an embodiment of a method of customised interaction with computer equipment according to an aspect of the disclosure. The first step is establishment 601 of a local connection between mobile computing apparatus and the computer equipment. In embodiments described in more detail below, the computer equipment may be a terminal (such as an ATM) of a financial transaction system and the mobile computing apparatus may be a payment card (such as an EMV card) or a proxy for a payment card (such as a mobile telephone running a suitable application). Other embodiments may relate to other technical areas. For example, this technology approach can be used for transportation systems, and the computer equipment may be a transport system ticket machine, and the mobile computing apparatus may be a smart ticket or a proxy for a ticket (such as, again, a mobile telephone running a suitable application).

The next step is the provision 602 of interaction code from the mobile computing apparatus to the computer equipment. As is discussed below, the interaction code is typically stored and used in such a way as to prevent the computer equipment from being compromised. The computer equipment then runs 603 the interaction code to provide a customised interface for the user. This will typically involve an interface which is configured according to the preferences of the user, thus allowing the user to have a consistent and preferred user interface whenever interacting with computer equipment of the relevant type.

Preferably, the computer equipment will be adapted to clear 604 the interaction code after use so that it is no longer present and will not affect any interaction with any other party. This will typically take place before ending 605 the local connection with the mobile computing apparatus, but may take place after this (possibly immediately after this).

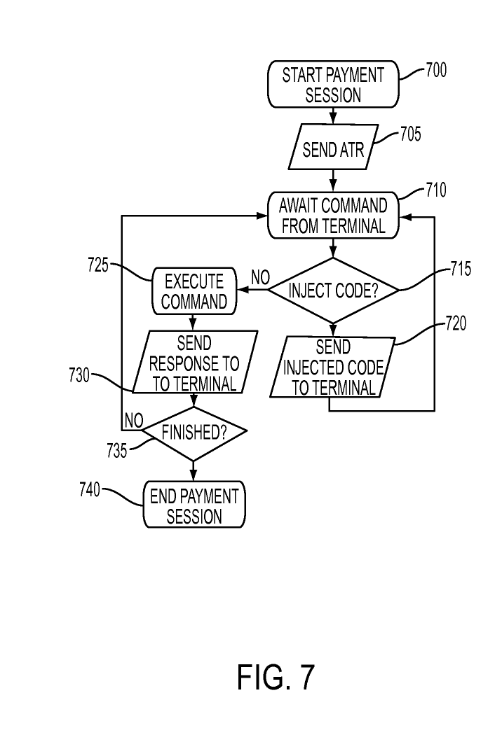

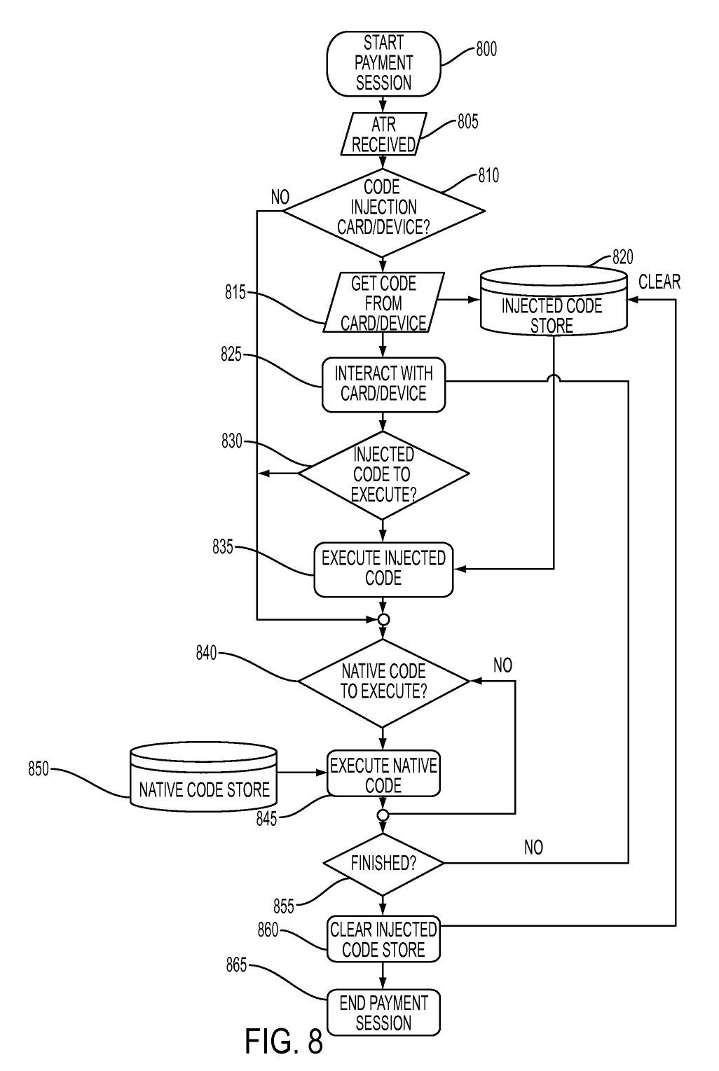

FIGS. 7 and 8 show method steps taking place at mobile computing apparatus and computer equipment respectively, where these method steps are used in implementing a method according to an embodiment of the disclosure. This embodiment is particularly appropriate for use where the mobile computing apparatus is a payment card, such as an EMV card, or a proxy for a payment card, and where the computer equipment is a terminal of a financial transaction system, such as an ATM.

For the purpose of describing the steps of FIG. 7, the mobile computing apparatus will be taken to be a payment card and the computer equipment a terminal of a financial transaction system. Processing starts 700 when a local interaction between the payment card and the terminal is initiated—this may be by introducing the payment card into a card reader of the terminal, or simply by moving the card (or the mobile payment device) into the interaction zone of the terminal in a contactless card system. The first message (or ATR) sent 705 by the payment card to the terminal may indicate that the payment card is capable of code injection. The payment card then awaits 710 a response (which may be in the form of a command) from the terminal.

The payment card has already indicated that it is capable of code injection. The response given by the terminal will indicate whether the terminal is capable of receiving the code injection, and optionally whether the terminal trusts the payment card or its guarantor sufficiently to accept an injection of code from it. There may, for example, be a cryptographic exchange between the payment card (for example, using a security domain provided by a secure element within the payment card). If the terminal is capable (and ready) to accept code, the decision 715 at the payment card will be to inject code by sending 720 injected code to the terminal. It should be noted that this may not be in response to the first command issued by the terminal. It may be, for example, that the terminal will not have determined that the transaction card can be trusted sufficiently for code injection to be accepted until after a handshaking procedure. If the payment card (or mobile device) and terminal agree that there is code to inject, then it is transferred to the injected code store in the terminal.

After the code has been injected, the payment card reverts to awaiting 710 a command from the terminal. When a command is received, the payment card in this case does not decide to inject code but instead executes 725 the command and sends 730 a response to the terminal, checking if the interaction is finished 735 and if not reverting to awaiting 710 a command from the terminal. Steps 710, 725, 730 and 735 form a standard command (e.g., an APDU command) processing loop for a payment card in an EMV interaction with a terminal. As noted above, such a command loop may take place before as well as after the code injection loop. It is also possible that there may be multiple code injection loops (and so multiple code injection steps) in the course of one payment session. This may happen if more user interface customisation is required, for example, if the user first makes a cash withdrawal transaction with one customised interface and then continues to make a bill payment with a second customised interface during the same payment session. When the interaction is finished 735 the payment session ends 740, for example when the payment card is removed from a card reader terminal or if the payment card (or mobile device) leaves a contactless card interaction zone.

The corresponding steps taking place at the terminal are shown in FIG. 8. Processing starts 800 when a local interaction between the payment card and the terminal is initiated to start a payment session. As stated above, this may be by introducing the payment card into a card reader of the terminal, or simply by moving the card into the interaction zone of the terminal in a contactless card system (e.g., when a NFC card or mobile device is tapped). The first message (or ATR) sent 805 received by the terminal from the payment card (or mobile device) may indicate that the payment card is capable of code injection. The terminal then determines 810 whether the payment card is a code injection device and whether the terminal is prepared to accept injected code from it (as indicated above, this may require additional commands to be performed before code injection takes place). If the payment card (or mobile device) does not support or contain code to inject, then processing proceeds based on native terminal code. If the terminal is prepared and ready to receive injected code, this is communicated to the payment card and code is received 815 from the payment card (or mobile device) and stored 820 in an injected code store. As discussed above, this may be a dedicated area of memory, an area of memory separated from the main memory by virtualization, or a physically distinct memory.

After injection of the code, the next step is that of interaction 825 between the payment card and the terminal. This may be simply the execution of the next command in an EMV session, for example, and as can be noted the flow will loop back to this point. There may be a further interaction 825 with the payment card before the injected code is executed (as shown). This will typically be the case if the injected code cannot be usefully executed until more information is learned from the transaction card or from the user (for example, there is no benefit in providing a user specific interface for a particular transaction if the user has not indicated that this transaction is to be carried out).

The next step is to determine 830 whether some or all of the injected code is to be executed at this point. If so, then the relevant injected code is retrieved from the code store and executed 835. If not, then the terminal jumps past this execution step.

After determining whether injected code is to be executed, it is determined 840 whether there is native code to be executed at this point. This may, for example, be a default code that may not have been replaced by the injected code, or it may relate to a function not affected by the injected code. The two code types may be executed together to determine different aspects of a user interface, and it may also be that native code is executed before injected code. The native code is retrieved 850 from a native (or built-in) code store (this may just be normal terminal memory) and executed 855. Again, if there is no native code to execute the terminal simply jumps past these retrieval and execution steps. The payment session is finished when the payment card (or mobile device) is withdrawn from the interaction zone of the terminal, or when indicated by application code.

The terminal then checks 855 to see whether there are further commands to execute and loops back to interaction step 825. If there are no more commands, the terminal clears 860 the injected code store so that this does not affect any future session involving any other user. For example, the injected code store in the terminal is physically erased at the end of the payment processing to safeguard the integrity of future sessions. After this the session ends 865, though as an alternative the clearing of the injected code store may take place after the session ends and as a direct consequence of it.

One issue that needs to be addressed is creation and updating of the code for code injection. This could be done in a number of different ways. One possibility is for a user to configure the user's own preferences for user interface customisation before a card is issued, for example by interaction with a card issuer website by an online banking interaction. Another possibility is for the card to be loaded with injectable code from a trusted source, such as at an ATM controlled by the card issuer or another source trusted by the user. A cryptographic exchange may take place before loading of the card with code for code injection to ensure that the card trusts the loading ATM sufficiently for this interaction to be permitted. Under these circumstances, the user interface may include user interface modification as an option selectable by the user. One possibility would be for some code injection options (such as which options would appear on an initial preferred interaction screen, say) to be modifiable at preferred or even all ATMs, with some options being unmodifiable or modifiable only by direct interaction with the card issuer.

Reference to standards and proprietary technologies are provided for the purpose of describing effective implementations, and do not limit the scope of the present disclosure.

1. A method of customised interaction with computer equipment comprising a processor, a display, a memory and a user data entry device, the method comprising:
establishing a local connection between mobile computing apparatus and the computer equipment, wherein the mobile computing apparatus includes a payment card or a mobile telephone acting as a proxy for a payment card, and wherein the computer equipment includes a terminal of a financial transaction system;
providing customised interaction code from the mobile computing apparatus for storage in the memory of the computer equipment; and
the processor of the computer equipment running the customised interaction code to provide a customised user interface using the display and the user data entry device during the local connection between the mobile computing apparatus and the computer equipment.

2. The method as claimed in claim 1, wherein the customised interaction code is deleted from the memory of the computer equipment after use of the customised user interface.

3. The method as claimed in claim 2, wherein the customised interaction code is deleted from the memory of the computer equipment before the local connection between the mobile computing apparatus and the computer equipment ends.

4. The method as claimed in claim 1, wherein the memory for storing the customised interaction code is a dedicated cache.

5. The method as claimed in claim 1, wherein the customised user interface provides user interface options previously determined by or for the user.

6. The method as claimed in claim 1, wherein the computer equipment establishes that the customised interaction code is provided or assured by a trusted source.

7. The method as claimed in claim 1, wherein the customised interaction code stored in the mobile computing apparatus is modified during the local connection.

8. (canceled)

9. (canceled)

10. The method as claimed in claim 7, wherein the terminal is an automated teller machine (ATM).

11. A method of using mobile computing apparatus to obtain a customised interaction with computer equipment comprising a processor, a display, a memory and a user data entry device, the method comprising:
establishing a local connection from the mobile computing apparatus with the computer equipment, wherein the mobile computing apparatus includes a payment card or a mobile telephone acting as a proxy for a payment card, and wherein the computer equipment includes a terminal of a financial transaction system; and
providing customised interaction code to the computer equipment over the local connection;
wherein the customised interaction code is adapted on being run by the computer equipment to provide a customised user interface using the display and the user data entry device during the local connection between the mobile computing apparatus and the computer equipment.

12. The method as claimed in claim 11, wherein the customised user interface provides user interface options previously determined by or for the user.

13. The method as claimed in claim 11, wherein the mobile computing apparatus provides evidence that the customised interaction code is provided or assured by a trusted source.

14. The method as claimed in claim 11, wherein the customised interaction code stored in the mobile computing apparatus is modified during the local connection.

15-18. (canceled)

19. A method of providing a customised interaction at computer equipment comprising a processor, a display, a memory and a user data entry device, the method comprising:
establishing a local connection from the computer equipment with mobile computing apparatus, wherein the mobile computing apparatus includes a payment card or a mobile telephone acting as a proxy for a payment card, and wherein the computer equipment includes a terminal of a financial transaction system;
receiving customised interaction code from the mobile computing apparatus and storing the customised interaction code in the memory of the computer equipment; and
the processor of the computer equipment running the customised interaction code to provide a customised user interface using the display and the user data entry device during the local connection between the mobile computing apparatus and the computer equipment.

20. The method as claimed in claim 19, wherein the customised interaction code is deleted from the memory of the computer equipment after use of the customised user interface.

21. The method as claimed in claim 20, wherein the customised interaction code is deleted from the memory of the computer equipment before the local connection with the mobile computing apparatus ends.

22. The method as claimed in claim 19, wherein the memory for storing the customised interaction code is a dedicated cache.

23. The method as claimed in claim 19, comprising establishing that the customised interaction code is provided or assured by a trusted source.

24. (canceled)

25. The method as claimed in claim 19, wherein the terminal is an automated teller machine (ATM).
